(19) United States
(12) Patent Application Publication
(10) Pub. No.: US 2013/0262272 A1
(43) Pub. Date: Oct. 3, 2013

(54) COUNTERTOP SELECTION, MARKETING AND PREVIEW SYSTEM

(71) Applicants: Nick Ritota, Adrian, MI (US); Noelle Masters Giblin, Spring Lake, NJ (US); George Scott Demand, Ocean Gate, NJ (US); Chadwick Thomas Miller, Onstead, MI (US); Robert Scott Biehler, Toms River, NJ (US)

(72) Inventors: Nick Ritota, Adrian, MI (US); Noelle Masters Giblin, Spring Lake, NJ (US); George Scott Demand, Ocean Gate, NJ (US); Chadwick Thomas Miller, Onstead, MI (US); Robert Scott Biehler, Toms River, NJ (US)

(21) Appl. No.: 13/433,594

(22) Filed: Mar. 29, 2012

(51) Int. Cl. G06Q 30/06

(52) U.S. Cl. 705/27.1

(57) ABSTRACT

A method for purchasing natural stone includes the steps of choosing a stone, measuring pieces of an environment in which the stone is to be placed, laying out measurements of pieces of the environment upon a slab of the stone, virtually cutting pieces of the slab according to the measurements in a first way, and, recreating the environment with the virtually cut pieces of the slab.

### TECHNICAL FIELD

This application relates to stone countertops, and more particularly to the marketing, sales and display of natural stone in a retail store.

### BACKGROUND

Buying granite or other natural stone for the home may be a difficult process. A purchaser usually goes to a wholesaler where stones of different quality, pattern and color are arrayed in long racks. A purchaser may have to wait to find a sales agent to go through the stones. Upon viewing the stones with the sales agent, the purchaser must guess as to whether the stones will be appropriate in their environment such as a kitchen or a bath or a playroom, for instance. A sophisticated purchaser may bring pictures of their environment with them to compare with the stones or the wholesaler may be able to provide a sample. However, the pictures brought by the user may not be truly representative of the environment and the provided sample may not be exact.

Because the stones are natural materials, stones that are variable over their surfaces in terms of color and pattern, may not translate well when put in the purchaser's environment.

### SUMMARY

According to an embodiment disclosed herein, a method for purchasing natural stone includes the steps of choosing a stone, measuring pieces of an environment in which the stone is to be placed, laying out measurements of pieces of the environment upon a slab of the stone, virtually cutting pieces of the slab according to the measurements in a first way, and, recreating the environment with the virtually cut pieces of the slab.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 is a depiction of a process to market stone to end users.

FIG. 2 is a depiction of a first color having a color range.

FIG. 3 is a depiction of the color of FIG. 2 with a different color range.

FIG. 4 is a depiction of a second color with a color range.

FIG. 5 is a depiction of a kiosk showing the cards of FIGS. 2, 3, and 4 and other features.

FIG. 6 is a lay-out view of a typical kitchen with countertops upon which stone is to be applied.

FIG. 7 is a depiction of a slab laying out the shapes of the countertops shown in FIG. 6 upon a chosen slab.

FIG. 8 is a model view of the kitchen of FIG. 6 with the chosen slab countertops depicted for purchaser review.

FIG. 9 is a depiction of a process to sell stone to end users.

### DETAILED DESCRIPTION

Referring now to step 15 in FIG. 1, a reseller for a store communicates with a natural stone vendor to create parameters relative to the quality of the stone surface such as: color including brightness (shading from light to dark), hue (the actual color by wavelength), and saturation (sharp to dull); fissures or pits per given area; variability of color across each slab etc. as will be discussed infra. The reseller than expects the vendor to provide slabs that meet such parameters.

In step 20, the natural stone vendor delivers the slabs into the reseller's warehouse. The slabs are then verified in step 25 in the warehouse to determine whether the stone conforms to the parameters that were set. The reseller may use observation, reference cards, machine vision or the like to determine whether the delivered slabs conforms to the parameters. If the slabs do not conform to the parameters, the slabs are rejected in step 30 and the reseller than communicates with the natural stone vendor to determine whether set parameters should change. If the number of slabs rejected exceeds a certain statistical limit, the parameters are changed and marketing materials will change as will be discussed infra.

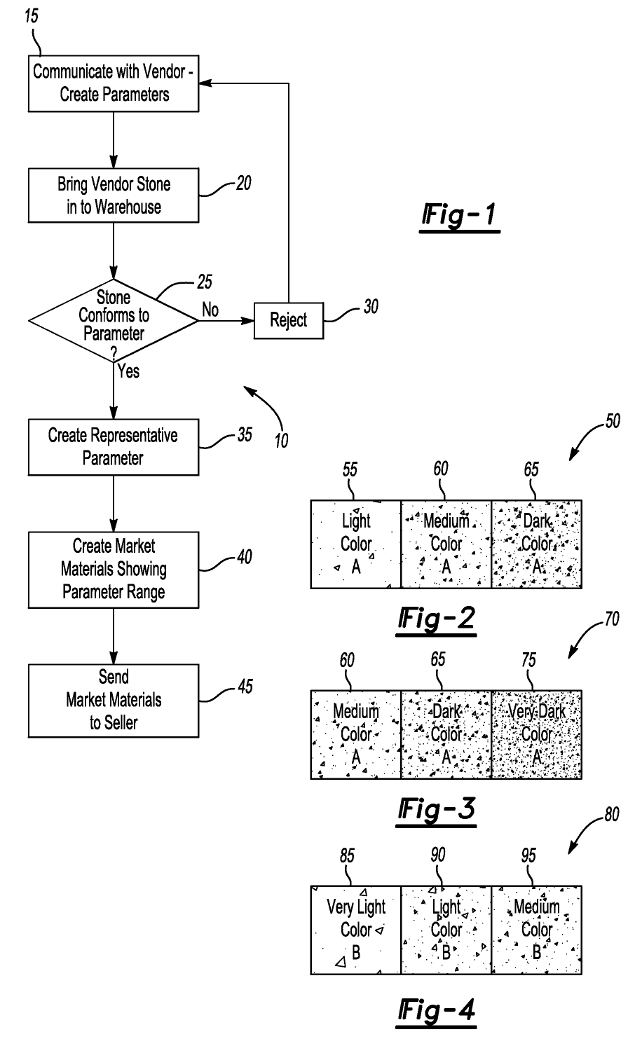

In step 35, once a slab conforms to the set parameters, a representative color is created by taking an image of that slab so that customers in a store may view marketing materials such as cards or brochures (see FIGS. 2-5) in a way that mimics the look of the slab in a natural environment even if the image is shown, for instance, in a fluorescently lit, big box store. The image is color balanced by correcting the color of the image such that the image, if viewed in the store, is deemed by a user to be in the 5500-6500 Kelvin range. [need more information here]

In step 40, marketing materials, as will be discussed infra, are printed using the color balancing in step 35 and made readily available to consumers in the store. The marketing materials include color range labels to be displayed on each granite sample displayed at a point of purchase kiosk, color range brochures, video screens and color range cards or the like. These marketing materials are then sent to the store so that natural stone may be sold from the warehouse directly to a consumer.

Because slab may be rejected in step 30 or because of the communication with the natural stone vendor in step 15, the reseller may know if stone cannot be provided that meet specified parameters. If the specified parameters cannot be met, new parameters are created.

Referring now to FIG. 2 sample color range card 50 is shown. The color card 50 relates to, for instance, the brightness characteristic of color and shows a light color A in 55 on the left side of the card. A medium color A on the center part of the card 60 and a dark color A is shown on the right side of the color card 65. This color card tells a buyer that even though they may order color A, because natural stone is variable, they may get a lighter shade 55, a medium shade 60 or a dark shade 65. Referring now to FIG. 2, a new color card 70 is shown that replaces the color card 50. Because of communication with the vendor in step 15 or rejection of a significant number of slabs in step 30, it is determined the color shades (or other parameters) shown in color card 50, can no longer be provided so that a new color card has to be created, for example, that still shows the availability of the medium color A-60, the dark color A-65, and the very dark color A-75. This means that the light color A is no longer available given the natural stone that is coming into the reseller's warehouse.

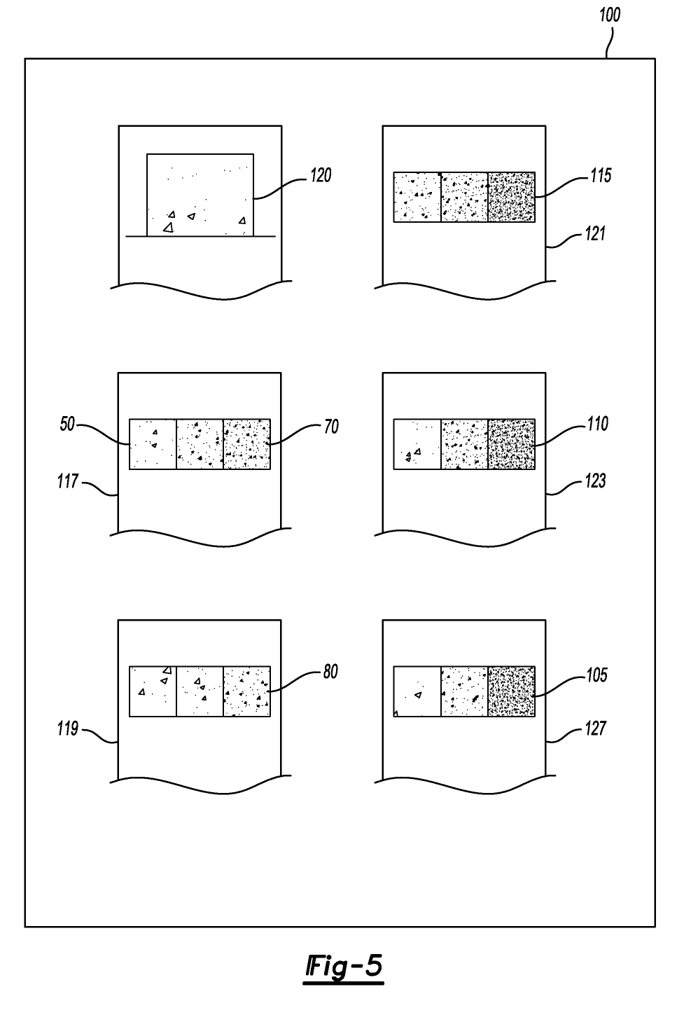

Referring to FIG. 4, one can see that a different color B is very light 85 and light in 90 and medium in 95. A worker of ordinary skill in the art will recognize that there are other colors 105, 110, 115 (see FIG. 5) with other ranges that may be available to consumers. One of ordinary skill in the art will also recognize from the teachings herein that the cards may exhibit other parameters besides brightness, including hue or saturation or others.

Referring now to FIG. 5, one can see a kiosk 100 having plurality of cards are shown with different colors with different ranges of color 50, 80, 105, 110, and 115. It should be noted that 50 could also be 70 if the color range in color 50 has changed. These color cards may be placed upon a representative center portion of an actual piece of a slab 117, 119, 121, 123, 127 so that the consumer can see the ranges up and down for that particular piece of stone. These color cards 50 or labels are placed on the color sample pieces of granite (or other stone) that are delivered to the store and, as noted above, the labels, cards and brochures 120 when shown in fluorescent light that which is observable in natural light in the buyer's kitchen or bath (not shown).

By providing a color range, a consumer is made aware of the color and character variances in the natural stone before a purchase is made thereby increasing customer satisfaction. This minimizes the need for a buyer to select their slab in person at an off-site fabricator, increasing the potential to close the sale in-store. By being able to view industry accepted variances in the color and character of each granite sample, under corrected lighting conditions, the homeowner is able to confidently select a stone choice that best works for his or her particular needs, style and taste. Also, the ability to select the stone in-store saves the homeowner the hassle, time and cost involved in traveling to an off-site fabricator. This is most often the case with traditional granite selection. Furthermore, the color corrected marketing materials allows the homeowner to more accurately visualize and project how each granite selection will look in his or her space.

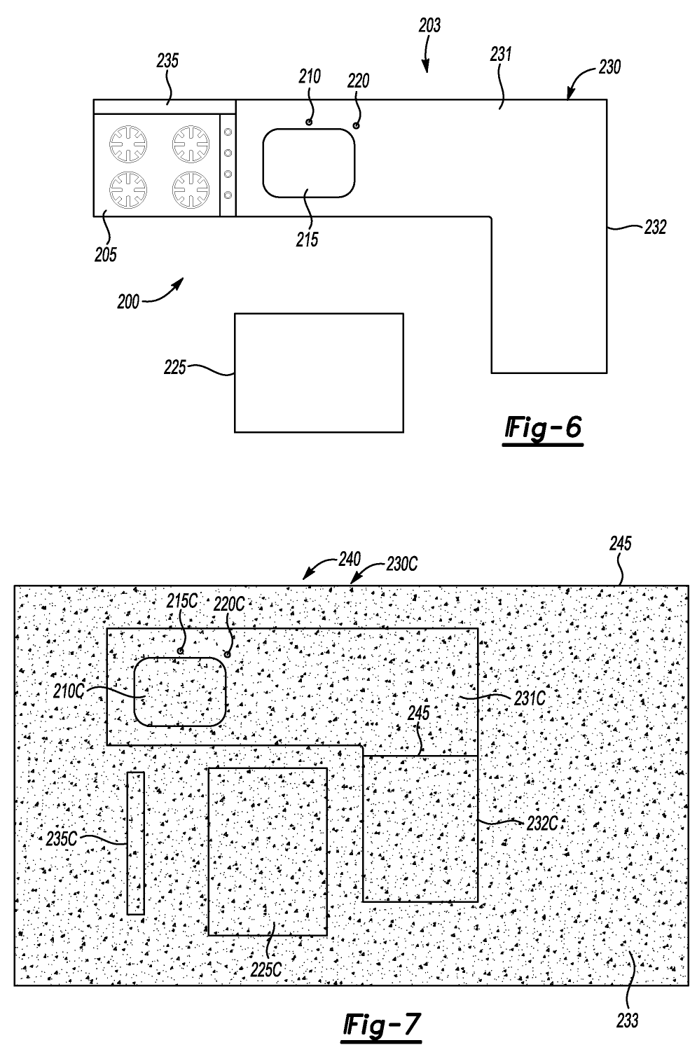

Once the customer has determined that shade and color (or other parameter) of stone desired, that customer contacts the reseller who comes out to their kitchen 200 as shown in FIG. 6 so that accurate measurements of the countertops 203 can be made. Measurements are made of the stove 205, the sink cutout 210, the faucet hole 215, the soap dispenser hole 220, the island 225, the L-shaped countertop 230, which has a long portion 231, including the sink cutout 210 and a short portion 232 extending perpendicularly to the long portion 231, and the back ledge 235, are entered into a CAD program.

These measurements are coordinated with a slab 240 (See FIG. 7) exhibiting the chosen parameters, including color and shade. The measurements are then laid up on the slab 240 to maximize use of the slab and to comply with the customer's wishes. For instance pieces relating to the sink cutout 210C, the faucet hole 215C, the soap dispenser hole 220C, the island 225C, the L-shaped countertop 230C, which has a long portion 231C, a short portion 232C, are shown. One of ordinary skill in the art will recognize that other layout patterns are available from each slab 240.

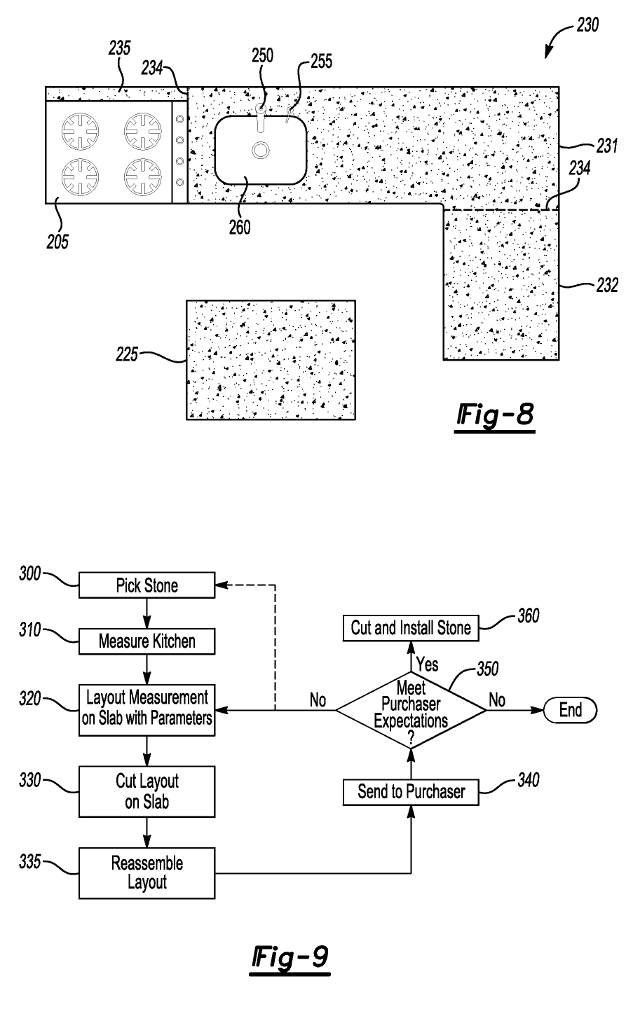

Once the slab is laid out, as shown in FIG. 8, slab with its actual cut lines as would be seen in the purchaser's kitchen, for instance, is shown. The cutout backsplash 235C is placed behind the stove 205. The L-shaped countertop 230 with its long portion 231 and a short portion 232 are shown connected to each other as if they were in the kitchen. Similarly, the island cutout 225C is placed where the island should be placed. As such, the purchaser can see an accurate representation of the kitchen they are purchasing with its stone countertops 203 installed. The lay-out shown in FIG. 8 may be e-mailed to the buyer. As an alternative, a life-size depiction (as represented in FIG. 8) of the lay-out may be sent to the buyer so that the lay-out may be actually placed on the buyers countertops to maximize a buying experience. The depiction may also be smaller. In either case the depiction as shown in FIG. 8 is color balanced to show the color and shade of the slab in natural light at about 5500-6500 Kelvin. The e-mailed or real depictions may also show appliances in the environment such as the stove 205, faucet 250, soap spigot 255, sink 260, etc.

Furthermore, the purchaser has the opportunity to go back to the store to re-layout the slab to get the look they prefer out of the slab 240. For instance as shown in FIG. 7, if a purchaser requires or desires a darker portion, the slab 231C and the slab 232C long portion and short portion could be slid farther to the right to utilize the darker or other portions of the slab 245 as opposed to the lighter or other portions of the slab where 245 the back ledge 35 portion of the island 225 are located. Once the purchaser has determined that slab is appropriately laid out for their kitchen 200, the slab 240 for the countertop 203 is then cut and installed. The countertop 203 may have seams 245 to make handling the slab easier to minimize a possibility of breakage.

Referring now to FIG. 9, step 300, the consumer picks the stone color with a promise of a particular shade from the marketing materials shown in FIG. 2-5. The store sends a worker to measure the kitchen 200 in step 310. Particularly as shown in FIG. 6, the worker measures the L-shaped countertop 230 including the long portion 231 and the short portion 32, the island 225, the placement of the soap dispenser 220, the placement of the faucet hole 215, the placement of the sink 210 and the back ledge 235. In step 320, the worker then inputs the measurements to a computer and lays out the required pieces of the slab, including the island 225C, backsplash 235C, and the L-shaped countertop 230 including the long portion 231C and the short portion 232C on a slab 240. The worker may attempts to lay the pieces out to comply with the purchaser's wishes in terms of shade and other parameters, such as veining or other parameters, and may include seams 245 to allow for ease of installation and to minimize breakage.

Referring now to step 330 a picture of the lay-out on the slab 240 is cut to create an image of the required pieces (e.g., the island 225, backsplash 235, and the L-shaped countertop 230 including the long portion 231 and the short portion 232). In step 335, the required pieces are reassembled with the stove 205, a faucet, and a soap dispenser included and with the island 225 place in the right place in relation to the L-shaped countertop 230 (see FIG. 8) to create an electronic depiction of how a user's actual kitchen will look. In step 340, this reassembled layout is then sent to the purchaser. If the layout meets the purchaser's expectations in step 350, the slab is then cut and installed as shown in 360 or the process may end. However, if the purchaser desires changes, the reseller may have the opportunity to layout the slab again in step 330 or let the buyer choose another stone in step 300 if iterations of the process are desired.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method for purchasing natural stone comprises the steps of:
choosing a stone,
measuring pieces of an environment in which said stone is to be placed,
laying out measurements of pieces of said environment upon a slab of said stone,
virtually cutting pieces of said slab according to said measurements in a first way,
and,
recreating said environment with said virtually cut pieces of said slab.

2. The method of claim 1 wherein said recreating step includes virtually recreating said environment.

3. The method of claim 2 further comprising the step of:
sending said virtually recreated environment to a buyer of said stone.

4. The method of claim 3 further comprising the step of:
deciding by said buyer whether said virtually recreated environment is acceptable.

5. The method of claim 4 further comprising the step of:
laying out measurements of pieces of said environment upon a slab of said stone in a second way if said virtually recreated environment is unacceptable.

6. The method of claim 5 wherein said second way captures different characteristics of said stone than said first way.

7. The method of claim 4 further comprising the step of:
choosing another stone if said virtually recreated environment is unacceptable.

8. The method of claim 1 further comprising the step of:
sending said recreated environment to a buyer of said slab.

9. The method of claim 8 further comprising the step of:
deciding by said buyer whether said recreated environment is acceptable.

10. The method of claim 9 further comprising the step of:
laying out measurements of pieces of said environment upon a slab of said stone in a second way if said virtually recreated environment is unacceptable.

11. The method of claim 10 wherein said second way captures different characteristics of said stone than said first way.

12. The method of claim 9 further comprising the step of:
choosing another stone if said virtually recreated environment is unacceptable.

13. The method of claim 8 wherein said recreated environment is life-size.

14. The method of claim 8 wherein said recreated environment is less than life-sized.

15. The method of claim 8 wherein said recreated environment is color-balanced to be viewed in 5500-6500 Kelvin light in a buyer's environment for accurate viewing of an actual color of said slab.

16. The method of claim 1 wherein said environment is a kitchen or a bathroom.
